(19) United States
(12) Patent Application Publication
(10) Pub. No.: US 2026/0239336 A1
(43) Pub. Date: Aug. 13, 2026

(54) Multiplexing Uplink Control Information Indicating Unused Configured Grant Resources

(71) Applicant: Apple Inc., Cupertino, CA (US)

(72) Inventors: Ping-Heng KUO, London (GB); Alexander SIROTKIN, Hod Hasharon (IL); Fangli XU, Beijing (CN); Haijing HU, Los Gatos, CA (US); Naveen Kumar R PALLE VENKATA, San Diego, CA (US); Peng CHENG, Beijing (CN); Ralf ROSSBACH, Munich (DE); Sethuraman GURUMOORTHY, San Ramon, CA (US); Yuqin CHEN, Beijing (CN); Zhibin WU, Los Altos, CA (US)

(21) Appl. No.: 19/155,409

(22) PCT Filed: Feb. 14, 2023
(86) PCT No.: PCT/CN2023/075967

§ 371 Date: Aug. 11, 2025

(51) Int. Cl. H04W 72/1268; H04L 1/1812; H04W 72/21

(52) U.S. Cl. CPC H04W 72/1268; H04L 1/1812; H04W 72/21

(57) ABSTRACT

A user equipment (UE) is configured to receive configured grant (CG) configuration information for a CG cycle comprising multiple Physical Uplink Shared Channel (multi-PUSCH) occasions for transmission of data, determine, by a Medium Access Control (MAC) entity of the UE, at least one unused PUSCH occasion of the multiple CG PUSCH occasions of the CG cycle, wherein an unused PUSCH occasion indicates the UE does not have any data to transmit in the unused PUSCH occasion, generate, by the MAC entity of the UE, information identifying the at least one of the unused CG PUSCH occasions, provide, by the MAC entity, the information to a physical layer or the UE and initiate a PUSCH transmission in one of the CG PUSCH occasions, wherein the PUSCH transmission comprises the information.

### TECHNICAL FIELD

The present disclosure generally relates to wireless communication, and in particular, to multiplexing uplink control information indicating unused configured grant resources.

### BACKGROUND

A Fifth Generation (5G) new radio (NR) network may support extended reality (XR) services. Due to the periodical nature of XR traffic, configured grants (CGs) may be used by the network for resource allocation. Certain characteristics of XR traffic such as, but not limited to, late packet arrival due to jitter and time-varying packet size may create scenarios where the resources allocated to the CGs for the XR traffic are unused. The UE may indicate to the network that CG Physical Uplink Shared Channel (PUSCH) resources are unused so that the network may reallocate these resources to the UE or other UEs, e.g., when the UE does not use all the PUSCH within a CG cycle with more than one PUSCHs, the UE may send an indication using Uplink Control Information (UCI) to notify the network. However, the manner of sending this UCI should be defined.

### SUMMARY

Some exemplary embodiments are related to a method performed by a user equipment (UE). The method includes receiving configured grant (CG) configuration information for a CG cycle comprising multiple Physical Uplink Shared Channel (multi-PUSCH) occasions for transmission of data, determining, by a Medium Access Control (MAC) entity of the UE, at least one unused PUSCH occasion of the multiple CG PUSCH occasions of the CG cycle, wherein an unused PUSCH occasion indicates the UE does not have any data to transmit in the unused PUSCH occasion, generating, by the MAC entity of the UE, information identifying the at least one of the unused CG PUSCH occasions, providing, by the MAC entity, the information to a physical layer or the UE and initiating a PUSCH transmission in one of the CG PUSCH occasions, wherein the PUSCH transmission comprises the information.

Other exemplary embodiments are related to a user equipment (UE) having a transceiver configured to communicate with a network and a processor communicatively coupled to the transceiver and configured to receive configured grant (CG) configuration information for a CG cycle comprising multiple Physical Uplink Shared Channel (multi-PUSCH) occasions for transmission of data, determine, by a Medium Access Control (MAC) entity of the UE, at least one unused PUSCH occasion of the multiple CG PUSCH occasions of the CG cycle, wherein an unused PUSCH occasion indicates the UE does not have any data to transmit in the unused PUSCH occasion, generate, by the MAC entity of the UE, information identifying the at least one of the unused CG PUSCH occasions, provide, by the MAC entity, the information to a physical layer or the UE and initiate a PUSCH transmission in one of the CG PUSCH occasions, wherein the PUSCH transmission comprises the information.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an exemplary scenario for time-varying packet size according to various exemplary embodiments.

FIG. 5 shows an exemplary technique for resource selection for UCI multiplexing according to various exemplary embodiments.

FIG. 6 shows an exemplary technique for enforcing UCI multiplexing with no data available according to various exemplary embodiments.

### DETAILED DESCRIPTION

The exemplary embodiments may be further understood with reference to the following description and the related appended drawings, wherein like elements are provided with the same reference numerals. The exemplary embodiments introduce techniques for handling unused configured grant (CG) resources indicated in dynamic uplink control information (UCI). In one aspect, the exemplary embodiments relate to a user equipment (UE) resource selection for UCI multiplexing. As will be described in more detail below, some of the exemplary techniques described herein may configure a user equipment (UE) to select specific physical uplink shared channel (PUSCH) resources within a CG cycle for UCI multiplexing. In another aspect, the exemplary embodiments relate to MAC handling of the unused CG resources. As will be described in more detail below, some of the exemplary techniques described herein may enable the MAC entity to model the unused transmission based on legacy UL skipping or refraining from delivering a grant to a HARQ entity. In a further aspect, the exemplary embodiments relate to enforcement of UCI multiplexing without user data. As will be described in more detail below, some of the exemplary techniques described herein may enable the UE to send UCI to the network (e.g., base station) to inform the network of the unused CG resources to allow the network to reallocate the resource for any other purpose, e.g., to other UEs. In another aspect, the exemplary embodiments relate to selecting alternative resources or UCI multiplexing resources. As will be described in more detail below, some of the exemplary techniques described herein may enable the UE to select an alternative resource transmit information. In a further aspect, the exemplary embodiments relate to applying a prioritization rule based on UCI multiplexing. As will be described in more detail below, some of the exemplary techniques described herein may enable the UE to ensure that the PUSCH with UCI indicating the unused CG resources are never de-prioritized.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to a 5G NR network that supports extended Reality (XR). Those skilled in the art will understand that XR is an umbrella term for different types of realities and may generally refer to real-and-virtual combined environments and associated human-machine interactions generated by computer technology and wearables. To provide some examples, the term XR may encompass augmented reality (AR), mixed reality (MR) and virtual reality (VR). While the exemplary embodiments are described with reference to XR, it should be understood that the exemplary embodiments may be applied to multiple configured grant (CG) PUSCH transmission mechanisms and dynamic indication of unused CG PUSCH resources that may be implemented by the UE to improve resource efficiency. That is, the exemplary embodiments are not limited to scenarios where the UE is engaged in XR operations.

XR services may utilize multiple data flows in the uplink and/or downlink. For example, in the downlink, there may be a video stream, an audio stream and/or a data stream. In the uplink, there may be a control stream and/or a pose stream. From a physical channel perspective, there may be different control channels and shared channels for each stream or multiple streams may share a control channel and/or shared channel. In some configurations, each stream may have different quality of service (QoS) requirements (e.g., block error rate (BLER), latency requirements, etc.).

For XR, data payload is typically periodical. For example, a video frame rate may be 60, 90 or 120 frames per second. The network may obtain assistance information related to the characteristics of the XR traffic and utilize the assistance information to perform resource allocation for the XR services. Due to the periodical nature of XR traffic, a configured grant (CG) resource allocation method may be used by the network for resource allocation.

XR traffic may have characteristics such as a quasi-periodic packet arrival rate due to random jitter and a packet size that may vary over time. To account for these types of characteristics, the network may configure multiple CG PUSCH transmission occasions in a period of a single CG configuration. However, when the UE is configured with the multiple CG PUSCH in the single CG configuration, the UE may identify a number of CG PUSCH that the UE does not intend to use. Accordingly, the UE may dynamically indicate the unused CG PUSCH occasions by sending an indication based on UCI to notify the network of the unused PUSCH per CG cycle. The network may in turn allocate the resource of unused PUSCH to other UEs and thereby improving the resource efficiency. However, for the UE to send the indication, the UE may multiplex the UCI into one CG PUSCH using a CG-UCI mechanism.

The exemplary embodiments introduce techniques for the dynamically handling uplink control information (UCI) indicating unused configured grant (CG) resources using CG-UCI mechanism. According to some aspects, the exemplary embodiments introduce techniques for the UE to select the PUSCH resource within a CG cycle for UCI multiplexing. In another aspect, the exemplary embodiments introduce techniques for a medium access control (MAC) layer to handle transmission opportunity for a CG resource that is declared to be unused. According to other aspects, the exemplary embodiments introduce techniques for the UE to send UCI to the network if no PUSCH is intended to be transmitted by the UE. Each of these exemplary techniques will be described in detail below. The exemplary techniques introduced herein may be used independently from one another, in conjunction with other currently implemented mechanisms for UCI multiplexing, in conjunction with future implementations of mechanisms for UCI multiplexing or independently from other mechanisms related to UCI multiplexing.

Additionally, the exemplary embodiments introduce techniques for the UE to concurrently handle multiple traffic flows with different latency requirements. The exemplary embodiment will be described in more details below.

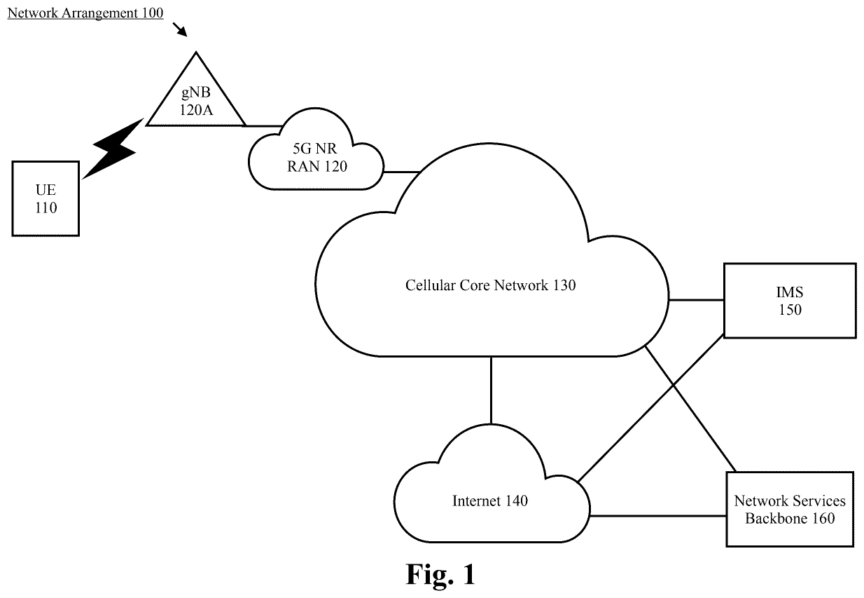

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables (e.g., head mounted display (HMD), AR glasses, etc.), Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with at least the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., qNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

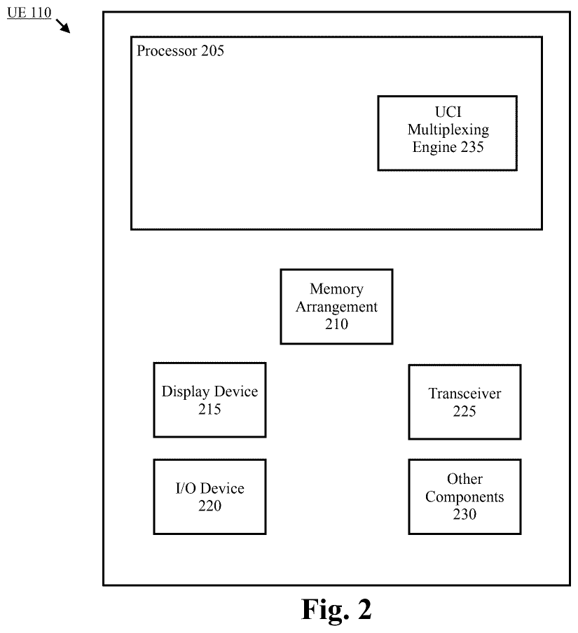

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute multiple engines of the UE 110. For example, the engines may include a UCI multiplexing engine 235. The UCI multiplexing engine 235 may perform a variety of operations for multiplexing UCI into a CG PUSCH resource and other related techniques described herein. The operations may include, but are not limited to, receiving multi-PUSCH CG configuration information, identifying unused CG PUSCH resources in the CG cycle, processing the unused PUSCH in the multi-PUSCH CG cycle using a MAC, handling multi-PUSCH CG without any data and transmitting UCI on PUSCH data that may be de-prioritized.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies).

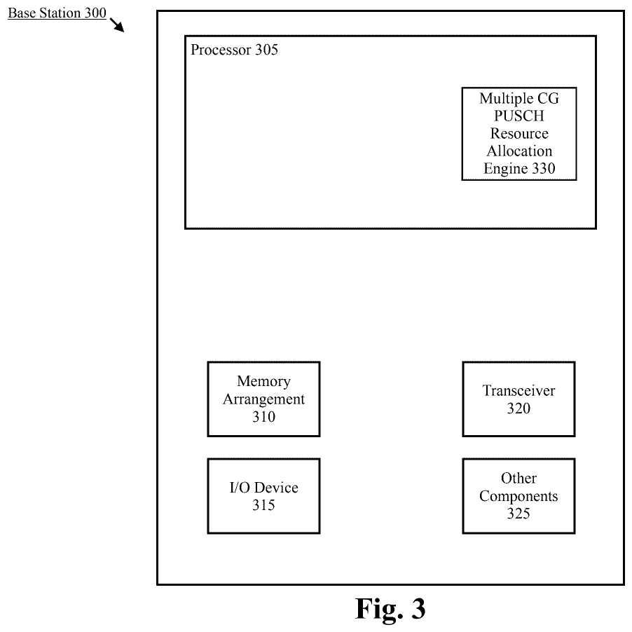

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a multiple CG PUSCH resource allocation engine 330. The multiple CG PUSCH resource allocation engine 330 may perform a variety of operations for configuring multiple CG PUSCH occasions in a period of single CG PUSCH configuration for the UE and other related techniques described herein. The operations may include, but are not limited to, allocating the resources of unused PUSCH to other UEs.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.) . The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs.

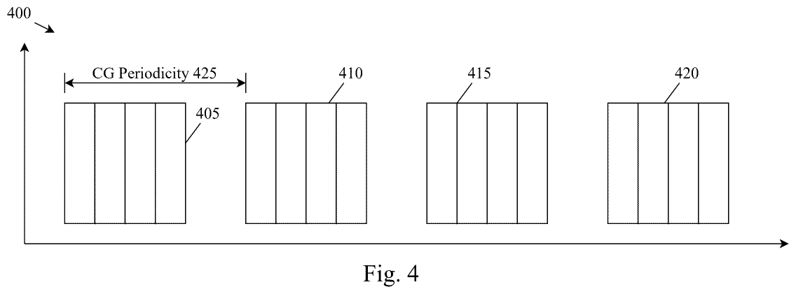

As mentioned above, the exemplary embodiments introduce techniques related to a UE 110 selecting a PUSCH resource within a CG cycle for UCI multiplexing. Prior to discussing the exemplary techniques introduced herein, an example scenario is described in FIG. 4 in which the UE 110 may receive multiple CG PUSCH occasions in a period of single CG PUSCH configuration to accommodate the periodic traffic with varying packet sizes. While the exemplary embodiments are described with reference to these aspects of XR traffic, it should be understood that the exemplary techniques introduced herein are not limited to these characteristics of XR traffic or even scenarios where the UE 110 is engaged in XR operations.

FIG. 4 shows an exemplary scenario 400 for time-varying size according to various exemplary embodiments. The exemplary scenario 400 is described with regard to the exemplary network arrangement 100 of FIG. 1, the UE 110 of FIG. 2 and the base station 300 of FIG. 3.

The scenario 400 comprises a first CG 405 with multiple PUSCH per period, second CG 410 with multiple PUSCH per period, third CG 415 with multiple PUSCH per period and forth CG 420 with multiple PUSCH per period. In the exemplary embodiment, the first CG 405, the second CG 410, the third CG 415 and the fourth CG 420 are separated by the CG periodicity 425.

In the scenario 400, the base station 300 configures the first CG 405, the second CG 410, the third CG 415 and the fourth CG 420 with multiple PUSCH per CG periodicity 425 for the UE 110 to accommodate XR traffic (e.g., audio, video, etc.) with varying packet sizes. Each CG 405, 410, 415 and 420 may comprise multiple PUSCH with different HARQ PIDs to accommodate the traffic. In some embodiments, when the UE 110 receives the multiple CG occasions for example first CG 405, the UE 110 may not utilize all the PUSCH within the first CG 405. Accordingly, the UE 110 may send an indication based on UCI to the base station 300 indicating the unused resources. The information conveyed by the indication may be determined/generated by the MAC layer. For example, the MAC layer can determine which PUSCHs will not be used based on the amount of buffered data and the MAC layer can further provide/deliver the information to the PHY layer for UCI transmission. The manner of sending the UCI to the base station 300 will be described in the in various exemplary embodiments described in more detail below.

As mentioned above, the exemplary embodiments introduce techniques for dynamically indicating the unused CG resources in the multi PUSCH CG occasion as will be described in more details below.

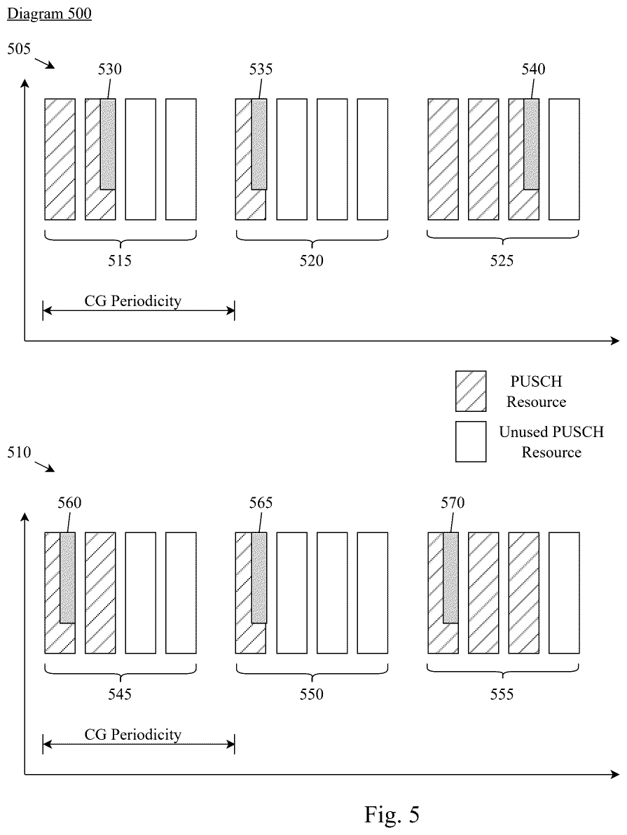

FIG. 5 shows an exemplary technique for resource selection for UCI multiplexing according to various exemplary embodiments. The exemplary technique 500 is described with regard to the exemplary network arrangement 100 of FIG. 1, the UE 110 of FIG. 2, the base station 300 of FIG. 3 and the scenario 400.

FIG. 5 shows two exemplary techniques 505 and 510. In 505, the UE 110 receives multiple PUSCH resources in CGs 515, 520 and 525 from the base station 300. In the exemplary embodiments, the UE 110 may identify PUSCH resources within the CG cycle that the UE 110 does not intend to use. The UE 110 may implement a technique of selecting a PUSCH resource within the CG cycle for UCI multiplexing to alert the network of the unused resources within the CG cycle. However, one skilled in the art will understand that the UCI is not limited to transmitting information of unused resources and may include other types of information as well.

Thus, in the example 505, the UE 110 may implement a technique to multiplex the UCI into the last PUSCH that the UE 110 may utilize within the CG cycle. For instance, in CG cycle 515, the UE 110 may only transmit data on the first and the second PUSCH within the CG cycle 515 while the third and fourth PUSCH within the CG cycle 515 remains unused. Thus, the UE 110 may multiplex the UCI 530 with the last PUSCH transmitting data to the network. For example, in CG cycle 515, the UE 110 may multiplex the UCI 530 with the second PUSCH since it is the last PUSCH the UE 110 may be utilizing within the CG cycle 515 for UL data. In another example of CG cycle 520, the UE 110 may transmit data only on the first PUSCH of the CG cycle 520 which is then considered to be the last PUSCH of the CG cycle 520 in which the UE 110 may be transmitting data. Accordingly, the UE 110 may multiplex the UCI 535 with the first PUSCH in CG cycle 520. To complete the example, the UE 110 may multiplex the UCI 540 with the third PUSCH in CG cycle 525 because the third PUSCH is the last PUSCH of the CG cycle 525 in which the UE 110 may be transmitting data. Thus, in this example 505, the UE 110 may be configured to multiplex the UCI with the last PUSCH of the CG cycles 530, 535 and 540 in which the UE 110 may be transmitting data.

In the example of 510, the UE 110 may implement a technique to multiplex the UCI on the k-th PUSCH of one multi-PUSCH CG cycle where k may be fixed or configured on a specific PUSCH within the CG cycle. In some exemplary embodiments, the UE 110 may select the first PUSCH, second, third, etc. as the k-th PUSCH to multiplex the UCI. As shown in the example 510, for the CG cycles 545, 550 and 555 (e.g., one multi-PUSCH CG cycle), the UE 110 may select the first PUSCH to multiplex the UCI within the multi-PUSCH CG cycle. Thus, in this scenario, the UE 110 may implement a technique to always multiplex the UCI to the first PUSCH within the multi-PUSCH CG cycle as shown by UCI 560, 565 and 570. In other exemplary embodiments, the UE 110 may set other PUSCH within the multi-PUSCH CG cycle that is carrying data as the k-th PUSCH to multiplex the UCI. For example, the UE 110 may be aware that at least two PUSCH resources will be used for each of the CG cycles for the multi-PUSCH CG cycle and therefore the UE 110 may dynamically configure the k-th PUSCH to be the second PUSCH.

The UE 110 may be preconfigured by the network to perform the operations as shown by example 505, e. g., multiplexing the UCI with the last PUSCH transmitting data to the network, or example 510, e.g., multiplexing the UCI on the k-th PUSCH of a multi-PUSCH CG cycle. This preconfiguration may be signaled to the UE 110 via, for example, Radio Resource Control (RRC) signaling, MAC Control Element (MAC CE), etc.

The exemplary embodiments also introduce other techniques for dynamically handling the unused CG resources in the multi PUSCH CG occasion. In another aspect, the exemplary embodiments introduce techniques for a medium access control (MAC) layer to handle transmission opportunity for a CG resource that is declared to be unused by the UE 110. As described above, after the UE 110 may have declared that a PUSCH within the multi-PUSCH CG cycle is “unused”, the UE 110 may send a corresponding UCI to the network indicating that the PUSCH is unused. However, after sending the corresponding UCI, the UE 110 may implement a technique that configures the MAC layer to handle or model the unused transmission opportunity within the multi-PUSCH CG cycle.

As those skilled in the art will understand, the MAC layer may be responsible for various operations related to a Hybrid Automatic Repeat Request (HARQ) for the transmissions on the PUSCH resources of the CG grants. Even though the UE 110 may not perform transmissions on these PUSCH resources, the MAC layer may still perform certain HARQ operations because these PUSCH resources have been allocated to the UE 110. Thus, the exemplary embodiments provide a manner of handling the unused CG resources in the MAC layer.

In some exemplary embodiments, the UE 110 may implement an uplink (UL) skipping mechanism. For example, the UE 110 may configure the MAC layer to still deliver the unused transmission opportunity to the HARQ entity for further processing. Although the transmission opportunity may be unused, the UE 110 may configure the MAC layer to always deliver the transmission opportunity to the HARQ entity. However, during this transmission, no MAC PDU is generated for this transmission opportunity. For example, whether a PUSCH has been declared to be unused may be a new condition for the UE 110 to determine if a MAC PDU should be generated for the PUSCH.

These exemplary embodiments may be encoded in specifications (e.g., 3GPP standards). An exemplary manner of expressing these exemplary embodiments in specifications may be as follows:

The mac entity shall:
1> if the MAC entity is configured with enhancedSkipUplinkTxDynamic with value true and the grant indicated to the HARQ entity was addressed to a C-RNTI, or if the MAC entity is configured with enhancedSkipUplinkTxConfigured with value true and the grant indicated to the HARQ entity is a configured uplink grant:
   2> if there is no UCI to be multiplexed on this PUSCH transmission as specified in TS 38.213[6]; and
   2> if there is no aperiodic CSI requested for this PUSCH transmission as specified in TS 38.212[9]; and
   2> if the MAC PDU includes zero MAC SDUs; and
   2> if the MAC PDU includes only the periodic BSR and there is no data available for any LCG, or the MAC PDU includes only the padding BSR:
      3> not generate a MAC PDU for the HARQ entity.
1> else if the grant indicated to the HARQ entity is a configured uplink grant comprising multiple PUSCHs:
   2> if this PUSCH is indicated to be unused:
      3> not generate a MAC PDU for the HARQ entity.

In other exemplary embodiments, the UE 110 may implement techniques that enable the MAC entity to refrain from delivering the unused transmission opportunity to the HARQ entity. For example, the MAC entity may consider the PUSCH that is declared to be unused as a deactivated configured grant. That is, in these exemplary embodiments, the UE 110 may configure the MAC layer to treat the transmission opportunity as a “deactivated” CG. As a result, the MAC layer may not deliver the CG and the associated HARQ information to the HARQ entity when the transmission opportunity is unused. However, although the CG may be deactivated for the transmission opportunity, the resource within the subsequent CG cycle may be activated. That is, the UE 110 may only suspend the declared unused resource in one CG cycle while activating the resource in a subsequent CG cycle. As another example, the MAC entity may treat the unused transmission opportunity as a configured grant with a HARQ process whose associated configured grant timer is running. As a result, the MAC layer may not deliver the CG and the associated HARQ information to the HARQ entity when the transmission opportunity is unused. Alternatively, the MAC entity may treat the unused transmission opportunity as a deprioritized uplink grant.

These exemplary embodiments may be encoded in specifications (e.g., 3GPP standards). An exemplary manner of expressing these exemplary embodiments in specifications may be as follows:

For each Serving Cell and each configured uplink grant, if configured, and activated, and not indicated to be unused, the MAC entity shall:
1> if the MAC entity is configured with Ich-basedPrioritization, and the PUSCH duration of the configured uplink grant does not overlap with the PUSCH duration of an uplink grant received in a Random Access Response or with the PUSCH duration of an uplink grant addressed to Temporary C-RNTI or the PUSCH duration of a MSGA payload for this Serving Cell; or
1> if the MAC entity is not configured with Ich-basedPrioritization, and the PUSCH duration of the configured uplink grant does not overlap with the PUSCH duration of an uplink grant received on the PDCCH or in a Random Access Response or the PUSCH duration of a MSGA payload for this Serving Cell:
   2> set the HARQ Process ID to the HARQ Process ID associated with this PUSCH duration;
   2> if, for the corresponding HARQ process, the configuredGrantTimer is not running and cg-RetransmissionTimer is not configured and cg-SDT-RetransmissionTimer is not configured (i.e., new transmission) and this PUSCH is not indicated to be unused:
      3> consider the NDI bit for the corresponding HARQ process to have been toggled;
      3> deliver the configured uplink grant and the associated HARQ information to the HARQ entity.

Again, the UE 110 may be preconfigured by the network to handle the unused CG resources in the MAC layer according to the exemplary embodiments described above, e.g., the uplink (UL) skipping mechanism or refraining from delivering the unused transmission opportunity to the HARQ entity. This preconfiguration may be signaled to the UE 110 via, for example, Radio Resource Control (RRC) signaling, MAC Control Element (MAC CE), etc.

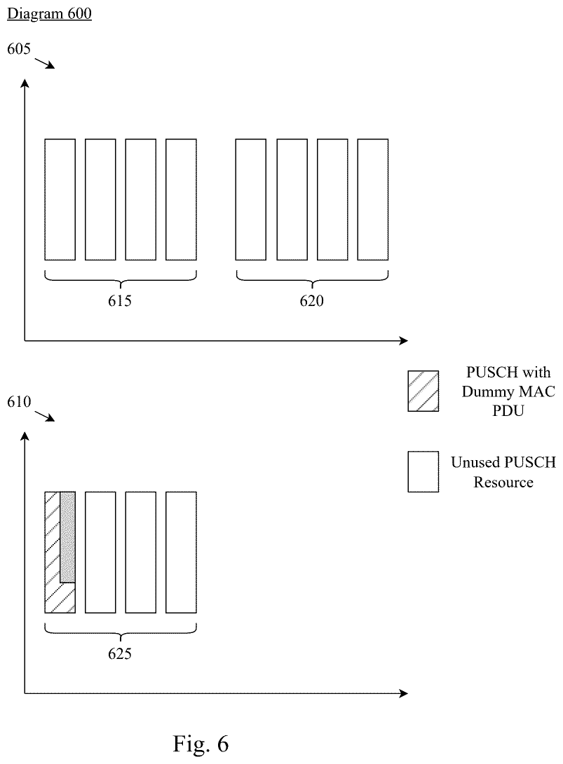

According to some exemplary embodiments, techniques for enforcing UCI multiplexing on PUSCH for a multi-PUSCH configured grant cycle without any user data are described. FIG. 6 shows an exemplary technique for enforcing UCI multiplexing on PUSCH without any user data according to various exemplary embodiments. The exemplary technique 600 is described with regard to the exemplary network arrangement 100 of FIG. 1, the UE 110 of FIG. 2, the base station 300 of FIG. 3 and the scenario 400.

FIG. 6 shows two exemplary scenarios 605 and 610. In 605, UE 110 may receive CG with multiple PUSCHs 615 and 620 from the network within each CG cycle. In the exemplary embodiments, the UE 110 may identify that multiple PUSCH within the CG cycles 615 and 620 in scenario 605 have no data to be transmitted in any of the PUSCHs. Although there may be no data available for the CG with multiple PUSCHs, the UE 110 may still implement a technique to send the UCI informing the base station 300 of the unused CG resources within the CG cycle to allow the base station 300 to allocate the resources to other UEs. For the UE 110 to multiplex the UCI, the UE 110 may generate a “dummy MAC PDU” for the PUSCH in the CG cycle that may be selected to carry the UCI. A dummy MAC PDU may be considered to be a MAC PDU without user data.

In other exemplary embodiments, the UE 110 may send the UCI on a resource that does not belong to this CG, such as a PUCCH resource or another PUSCH that is not associated with this CG. However, in such cases the UCI may further include an indication to identify the concerned CG.

As shown in 610, the UE 110 may generate the dummy MAC PDU on the first PUSCH in 625 and multiplex the UCI to the PUSCH. That is, although there may be no data in the buffer that can use the PUSCH, the UE 110 may still implement this technique to allow the PHY layer to perform the UCI multiplexing on the PUSCH.

The exemplary embodiment may be further described with scenario 610 of FIG. 6 in a series of steps. Prior to performing the steps, the UE 110 may implement a technique to always select the first PUSCH for UCI multiplexing regardless of whether there is data available in the buffer that may utilize such a PUSCH. In the first step, the UE 110 may determine that there is no uplink data to be transmitted on a multi-PUSCH CG (e.g., see scenario 605 of FIG. 6). In the second step, the UE 110 may configure the MAC layer to generate a MAC PDU (for example, without any user data) for the first PUSCH and deliver the MAC PDU to the PHY layer. In the third step, the MAC may also provide information about the unused CG resources to the PHY layer. Thus, in the fourth step, the PHY layer may perform a transmission of the first PUSCH with the dummy PDU and additionally perform UCI multiplexing to include the information about the unused CG resources obtained in the third step. Additionally, in this step, the UE 110 may opt to not start the configured grant timer for this PUSCH transmission.

Lastly, in the fifth step, the MAC layer may also consider the remaining PUSCHs in the multi-PUSCH CG cycle as “unused” since the dummy MAC PDU is only generated for the first PUSCH. These remaining unused PUSCH may be treated, for example, in accordance with the above described exemplary embodiments regarding the MAC layer and the HARQ entity. Accordingly, in the exemplary embodiments, although there may be no data to be transmitted, the MAC layer may still generate a MAC PDU entity such that the PHY layer may multiplex the UCI with the MAC PDU.

In other exemplary embodiments, techniques for alternative resource selection for UCI multiplexing are introduced. In the exemplary embodiments, the PUSCH carrying the UCI may be de-prioritized. As a result, the UE 110 may need to select an alternative resource to send the UCI.

For example, the MAC layer may identify which CG resources (e.g., within the CG cycle) are not to be used. Once the resources are identified, the MAC layer may provide such information to the PHY layer and instruct the PHY layer to transmit the information via UCI. The PHY layer may multiplex the UCI with a PUSCH of the multi-PUSCH CG along with the MAC PDU for the PUSCH (e.g., in accordance with the exemplary embodiments described above). However, if the PUSCH resource selected by the UE 110 is de-prioritized, the network will not receive the UCI because the PUSCH resource may not be completely transmitted because of the de-prioritization. Thus, the UE 110 may select another resource to send the UCI, e.g., the MAC layer may communicate with the PHY layer to deliver the UCI based on the updated information.

In a first example, the UCI may be multiplexed with a different PUSCH of the same CG cycle, e.g., the next PUSCH comprising a data transmission. However, if there is no data available for transmission on the next PUSCH, the UE 110 may generate a dummy PDU as described in the examples above and multiplex the UCI on the PUSCH with the dummy PDU. Thus, the network will receive the information concerning the unused PUSCH resources.

In a second example, the UE 110 may generate a MAC Control Element (MAC CE) that includes the information concerning the unused PUSCH and transmit the MAC CE in a subsequent PUSCH resource in the same CG cycle. In this example, the information concerning the unused PUSCH resources is conveyed using the MAC CE rather than the UCI. Again, even if the UE 110 does not intend to use this subsequent PUSCH for a data transmission, the MAC may generate a dummy MAC PDU to convey the MAC CE. Thus, the network will receive the information concerning the unused PUSCH resources.

In a third example, the UE 110 may multiplex the UCI with the PUSCH of the prioritized grant, e.g., the PUSCH transmission that de-prioritized the CG grant PUSCH transmission originally scheduled to carry the UCI. Thus, the network will receive the information concerning the unused PUSCH resources.

In a fourth example, the UE 110 may again generate a MAC CE that includes the information concerning the unused PUSCH and transmit the MAC CE in the PUSCH of the prioritized grant, e.g., the PUSCH transmission that de-prioritized the CG grant PUSCH transmission originally scheduled to carry the UCI. In this example, the information concerning the unused PUSCH resources is conveyed using the MAC CE rather than the UCI. Thus, the network will receive the information concerning the unused PUSCH resources.

In a fifth example, the UE 110 may transmit the information on a Physical Uplink Control Channel (PUCCH) resource as a standard UCI.

In some exemplary embodiments, prioritization rules may be introduced to ensure that the PUSCH carrying the UCI indicating the unused CG resources are not de-prioritized, e.g., the issue described above with respect to de-prioritization will not occur.

In one example, an intra-UE prioritization rule may be defined such that the PUSCH carrying the UCI indicating the unused CG resources may be set to the highest priority. The UE 110 may implement this rule regardless of the MAC PDU contents (e.g., LCH priority) and/or L1 (i.e., physical layer) priority of the grant, e.g., the priority of the grant may be determined by whether the UCI relating to identification of unused CG resources is multiplexed into its PUSCH or not.

In another example, different PUSCHs within a multi-PUSCH CG cycle may have different pre-set priority levels that may either be fixed pattern or a configurable pattern. Thus, for example, the first PUSCH may always be set to have a high priority, while the remaining PUSCH within the same multi-PUSCH CG cycle may have lower priorities. Additionally, the UE 110 may only be allowed to multiplex the UCI indicating the unused CG resources into the PUSCH with the high priority to ensure that the PUSCH is never de-prioritized. Thus, following the above example, the UE 110 may only be allowed to multiplex the UCI indicating the unused CG resources into the first PUSCH of the multi-PUSCH CG cycle.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method performed by a user equipment (UE), comprising:
receiving configured grant (CG) configuration information for a CG cycle comprising multiple Physical Uplink Shared Channel (multi-PUSCH) occasions for transmission of data;
determining, by a Medium Access Control (MAC) entity of the UE, at least one unused PUSCH occasion of the multiple CG PUSCH occasions of the CG cycle, wherein an unused PUSCH occasion indicates the UE does not have any data to transmit in the unused PUSCH occasion;
generating, by the MAC entity of the UE, information identifying the at least one of the unused CG PUSCH occasions;
providing, by the MAC entity, the information to a physical layer or the UE; and
initiating a PUSCH transmission in one of the CG PUSCH occasions, wherein the PUSCH transmission comprises the information.

2. The method of claim 1, further comprising:
transmitting the PUSCH transmission in the one of the CG PUSCH occasions.

3. The method of claim 1, wherein the information is included in uplink control information (UCI).

4. The method of claim 3, wherein the PUSCH transmission comprising the UCI is a last PUSCH occasion within the CG cycle having a PUSCH transmission with data.

5. The method of claim 3, wherein the PUSCH transmission comprising the UCI is configured to be in a fixed one of the multiple CG PUSCH occasions of the CG cycle.

6. The method of claim 1, further comprising:
delivering, by a Medium Access Control (MAC) layer of the UE to a Hybrid Automatic Repeat Request (HARQ) entity of the UE, a transmission opportunity and associated HARQ information; and
determining, by the UE, whether a MAC Protocol Data Unit (PDU) is generated for the transmission opportunity based on at least the transmission opportunity corresponding to the unused CG PUSCH occasion.

7. The method of claim 1, wherein a Medium Access Control (MAC) layer of the UE refrains from delivering the unused CG PUSCH occasion and associated Hybrid Automatic Repeat Request (HARQ) information to a HARQ entity of the UE.

8. The method of claim 1, wherein the MAC entity of the UE determines the least one unused PUSCH occasion of the multiple CG PUSCH occasions of the CG cycle based on at least an amount of user data buffered in at least one logical channel of the UE.

9. The method of claim 1, wherein the unused CG PUSCH occasion comprises a plurality of unused CG PUSCH occasions, wherein the PUSCH transmission comprising the UCI is scheduled for one of unused CG PUSCH occasions, the method further comprising:
Generating a MAC PDU that comprises no user data for the one of unused CG PUSCH occasions and multiplexing the UCI with the MAC PDU of the one of unused CG PUSCH occasions for the PUSCH transmission.

10. The method of claim 9, wherein a configured grant timer is not started for the PUSCH transmission.

11. The method of claim 1, wherein the PUSCH transmission is deprioritized by a higher priority grant.

12. The method of claim 11, further comprising:
providing the information in a PUSCH transmission of the higher priority grant.

13. The method of claim 11, further comprising:
generating a Medium Access Control Control Element (MAC CE) comprising the information; and
transmitting the MAC CE in a PUSCH transmission of the higher priority grant.

14. The method of claim 11, further comprising:
transmitting the information in a PUSCH transmission in a subsequent PUSCH occasion of the CG cycle.

15. The method of claim 14, wherein the subsequent PUSCH occasion of the CG cycle is an unused CG PUSCH occasion, the method further comprising:
updating the information based on the subsequent PUSCH occasion of the CG cycle being used to transmit the information; and
generating a MAC PDU that comprises no user data for the subsequent PUSCH occasion, wherein the updated information is provided in the MAC PDU that comprises no user data.

16. The method of claim 11, further comprising:
generating a Medium Access Control Control Element (MAC CE) comprising the information; and
transmitting the MAC CE in a subsequent PUSCH occasion of the CG cycle.

17. The method of claim 16, wherein the subsequent PUSCH occasion of the CG cycle is an unused CG PUSCH occasion, the method further comprising:
generating a MAC PDU that comprises no user data for the subsequent PUSCH occasion, wherein the MAC CE is transmitted using the MAC PDU that comprises no user data.

18. The method of claim 11, further comprising:
transmitting the information in a Physical Uplink Control Channel (PUCCH) resource.

19. The method of claim 1, wherein the PUSCH transmission with the information is assigned a highest priority with respect to any other PUSCH transmission.

20. The method of claim 1, wherein each PUSCH occasion of the CG cycle comprises a pre-set priority level, wherein the PUSCH transmission is configured for a PUSCH occasion having a highest priority level.
